(19) United States
(12) Patent Application Publication
(10) Pub. No.: US 2008/0007555 A1
(43) Pub. Date: Jan. 10, 2008

(54) DYNAMIC PLOT ON PLOT DISPLAYS

(76) Inventors: Joseph A. Vrba, Clinton, TN (US); William P. Broussard, Knoxville, TN (US)

Correspondence Address: LUEDEKA, NEELY & GRAHAM, P.C., P O BOX 1871, KNOXVILLE, TN, 37901, US

(21) Appl. No.: 11/456,382

(22) Filed: Jul. 10, 2006

(51) Int. Cl. G06T 11/20

(52) U.S. Cl. 345/440

(57) ABSTRACT

A method and apparatus for simultaneously displaying secondary data with primary data using an interactive display system. The invention allows for a user to generate views of the secondary data alongside or superimposed on a graph of the primary data. The method and apparatus may be used to display test data involving multiple dimensions, such as RPM, vibration and displacement trend data collected from multiple sensors during the testing or monitoring of a machine.

### FIELD

This invention relates to the field of data display. More particularly, this invention relates to a system for displaying data in a more user-friendly and efficient manner.

### BACKGROUND

Data display technology has become a paramount tool in the information age. The need for data analysts to have large sums and varied types of data at their fingertips has never been more desirable. However, as many types of data analysts, including engineers, soldiers, pilots, and executives, have come to realize, the display of too much data at one time has the potential of undermining an original purpose of the data collection—to understand the current status and trends of a particular system or systems. When the addition of data translates into less clarity for an analyst, the perceived benefit of having more information actually becomes a detriment for the analyst. Based on these realities, many data accumulation and display technologies incorporate creative ways to package large sums of data into understandable and meaningful information for an analyst.

For example, in manufacturing and other industrial environments, machines are often monitored to detect faults and verify proper operation. A machine's vibration may be continuously monitored and alarms generated if the vibration exceeds a predetermined threshold at some frequency of interest. Practically any number and type of variable, including temperature and fluid pressures, may be monitored. These monitoring systems typically incorporate various types of sensors attached to one or more monitored machines. These sensors generate signals that are transferred to a computer where they are analyzed and in some cases stored for future reference.

Monitoring of systems is most critical when a the system is undergoing some type of transition. For example, during the start up of a large turbine, close monitoring of any vibrations of the rotor is essential to prevent possible damage. During the period while the state of the system is changing, sensor data is collected continuously. Such data, collected during system transients, is commonly referred to as transient data. Depending on the item being monitored (e.g., a machine, an animal, the environment) and the type of data collected, transient data sets and other similar data sets are typically displayed on two-dimensional dynamic plots for active analysis. These data displays often provide a primary graphical view showing the interrelation of two primary trend variables of interest, such as rotations per minute (RPM) versus time for a rotating machine. The type of data that is primarily monitored depends on the monitored item and the related process.

In a considerable number of monitoring applications, a number of important variables other than the primary trend variables are monitored. These “secondary” variables may be of interest to the analyst, but not as critical to the minute-by-minute operation of a particular monitored item and related process. In many monitoring applications, the simultaneous display of all of the sensory data, primary and secondary, at a display device can be overwhelming to the analyst. Similarly, the intermittent display of all or most of the sensory input with many displays being presented in a monotonous series may have the effect of confusing an analyst as to what is being displayed at any given time or, perhaps worse, causing an analyst to become complacent because of the ever-changing views shown on the display.

What is needed, therefore, is the ability to continuously monitor dynamic primary trend variables while retaining the option to select a point or region on the primary trend data plot and obtain a graphical “snapshot” of one or more secondary data variables at the selected point or region.

### SUMMARY

The above and other needs are met by a method for displaying multidimensional data on a display device, where the multidimensional data includes primary data and secondary data. The method includes the steps of (a) displaying a graph of at least a portion of the primary data on the display device in a first graphing format, (b) selecting a first reference point in the displayed graph of the primary data, (c) accessing a first requested data set from the secondary data, where the first requested data set is indicated by the first reference point, and (d) displaying a graph of the first requested data set in a second graph superimposed on the display device with the graph of the primary data. Employing this embodiment of the method, a user generates a “snapshot” of the behavior related to the one or more types of secondary data corresponding to the selected first reference point in the primary data.

In preferred embodiments, a user selects a graph format for the secondary data, and then selects a particular range of data points in the primary data using an input device (e.g., a mouse), thereby defining the first requested data set. The interactive display device then displays the secondary data corresponding to the first requested data set, so that the selected portion of the secondary data is displayed with the primary data.

Preferably, the first requested data set is displayed in a display window on the display device with the graph of the primary data. In some embodiments, the display window is superimposed over at least a portion of the graph of the primary data. The user may adjust a transparency setting associated with the superimposed display window so that the superimposed display window does not fully block the graph of the primary data. Additionally, the display window may be repositioned along the display device based on a user's viewing preference. The display window may also be expanded, minimized or maximized.

In another aspect, the invention provides an apparatus for displaying multidimensional data including primary data and secondary data. In preferred embodiments, the apparatus includes an interactive display system and plot-on-plot computer software and/or firmware running on the interactive display system. Primary data is displayed on a monitoring screen that is part of the interactive display system. A mouse, touchpad, touch screen or other similar input means are used to input a graphing format selection for the interactive display device using. A user may also select a reference point along the displayed primary data using the input device. Upon selection of a reference point, the application software and/or firmware operates to access a requested data set and display the requested data set in the chosen graph format along with the primary data on a display screen of the interactive display system.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 depicts a preferred embodiment of an apparatus for generating plot-on-plot displays including an interactive display system in communication with a mass storage device;

FIG. 2 depicts a view of two-dimensional primary data (RPM versus time) displayed using an interactive displayed device according to a preferred embodiment of the invention;

FIG. 3 depicts a view of primary data (RPM versus time) displayed with one selection of secondary data graphed as an orbital plot at a particular point in the primary data;

FIG. 4 depicts a view of primary data (RPM versus time) displayed with a plurality of selections of secondary data graphed as orbital plots at selected points in the primary data;

FIG. 5 depicts a view of primary data (shaft centerline plot) displayed with a plurality of selections of secondary data graphed as orbital plots at selected points in the primary data; and

FIGS. 6 and 7 depict methods for generating plot-on-plot displays according to preferred embodiments of the invention.

### DETAILED DESCRIPTION

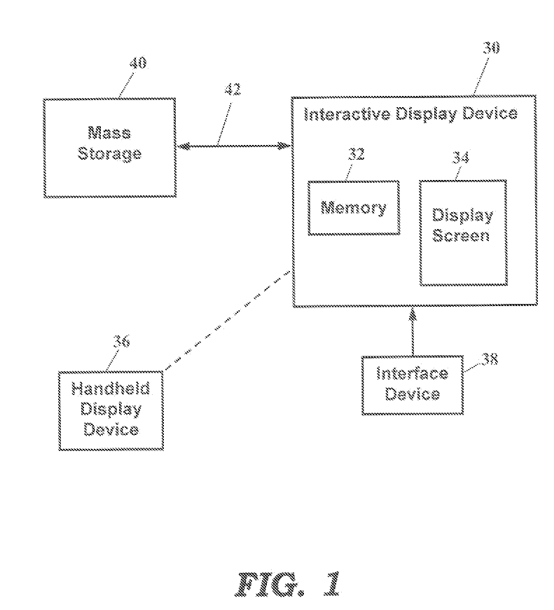

FIG. 1 depicts a preferred embodiment of an apparatus for implementing the plot-on-plot data display methods described herein. As shown in FIG. 1, the apparatus includes an interactive display device 30 which preferably includes on-board memory 32 for storing or loading data to be displayed. The on-board memory 32 may be in the form of volatile memory, non-volatile memory or a combination of both. The device 30 also includes a display screen 34 which may comprise a CRT, LCD or plasma screen, or any other similar display means known to those skilled in the art. The display device 30 may incorporate a handheld device 36 that is operable to display the primary and secondary data as described herein and to at least receive data via wireless communication. In a preferred embodiment, a separate user input device 38, such as a mouse, touchpad, touch screen or other similar input device, is in communication with the interactive display device 30. In another embodiment, a user may interact with the display device 30 directly, such as by using a touch screen, interactive voice commands or other similar direct communication means. In preferred embodiments, the interactive display device 30 interacts with a server or other device connected to local area network, wide area network, the Internet or any other communication network.

In a preferred embodiment, the interactive display device 30 is in communication with a mass storage device 40 via a communication network 42. Alternately, the mass storage device 40 may be contained within the interactive display device 30. The mass storage device 40 may be any nonvolatile data storage device in which a large quantity of data is stored, such as a magnetic or optical hard drive or a flash memory device. The communication network 42 may comprise any means of communicating data, such as a hardwired network (e.g., electrical or fiber-optic), a wireless network (e.g., infrared or RF) or a combination of hardwired and wireless networks. In the preferred embodiment, requests for data (including primary data or secondary data requests) are sent via the communication network 42 to the mass storage device 40, and the requested data is provided to the interactive display device 30 via the communication network 42.

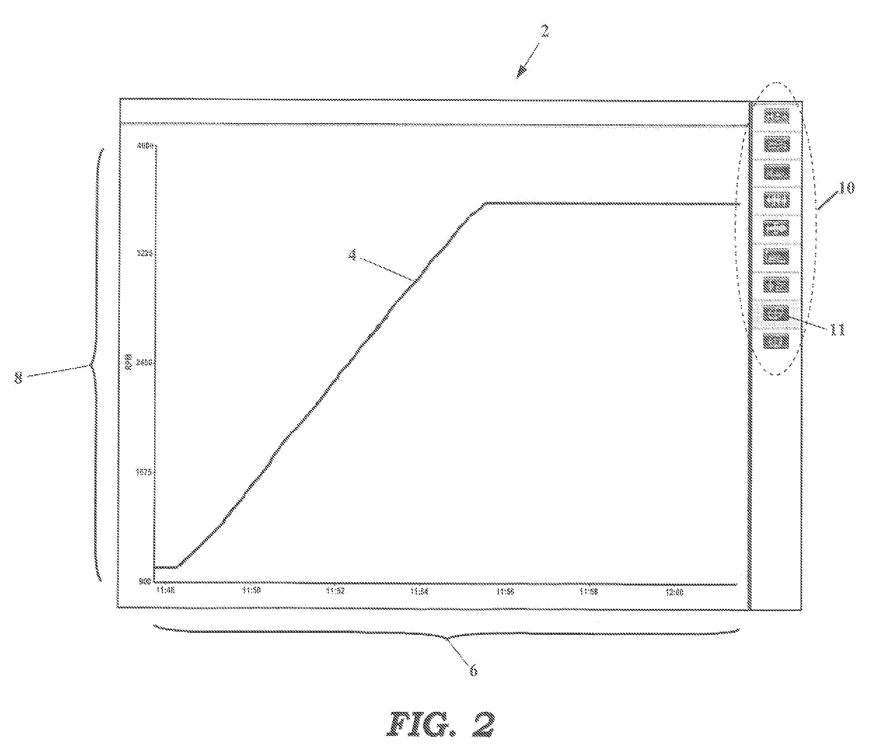

FIG. 2 shows a first graph 2 of data displayed on the display screen 34 of the interactive display device 30. The first graph 2 shows primary data 4 plotted in a two-dimensional format. In this example, the primary data 4 is displayed as RPM versus time for a turbine during a time period in which turbine operation transitions from a lower speed state to a higher speed state and is then held at the higher speed state. The time component is measured along the X-axis 6 and the RPM component is measured along the Y-axis 8. The first graph 2 also shows a plurality of graph icons 10 from which a user can select the manner in which to plot secondary data. For example, a user may select an orbital graph icon 11 to generate an orbital plot of relative shaft position versus rotation angle. It should be understood that the methods and apparatus described herein are not limited to any particular type of graphical representation. Thus, the invention is applicable to any number of dimensions, any sources or types of data and any manner of graphically representing data.

With reference to FIGS. 1, 3 and 6, the primary data 4 is plotted in the first graph 2 on the display screen 34 of the interactive display device 30 (step 100). A user then selects a graphing format for displaying secondary data by selecting the orbital graph icon 11 from among the plurality of graph icons 10 (step 102). Subsequent or prior to the selection of the graphing format for the secondary data, the user selects a first reference point 12 on the graph of the primary data 4 (step 104). In a preferred embodiment, selection of the first reference point 12, defines a first requested data set containing secondary data. Thus, the first requested data set is a set of secondary data associated with the primary data 4 displayed at the first reference point 12. During or subsequent to the selection of the first reference point 12, a subplot 14 comprising a graphical representation of the first requested data set is superimposed on the first graph 2 (step 106). In the preferred embodiment, the format of the subplot 14 corresponds to the graph icon previously selected by the user (e.g., the orbital graph icon 11). Preferably, an indicator 16 also appears with the subplot 14 to visually associate the subplot 14 with the selected reference point 12.

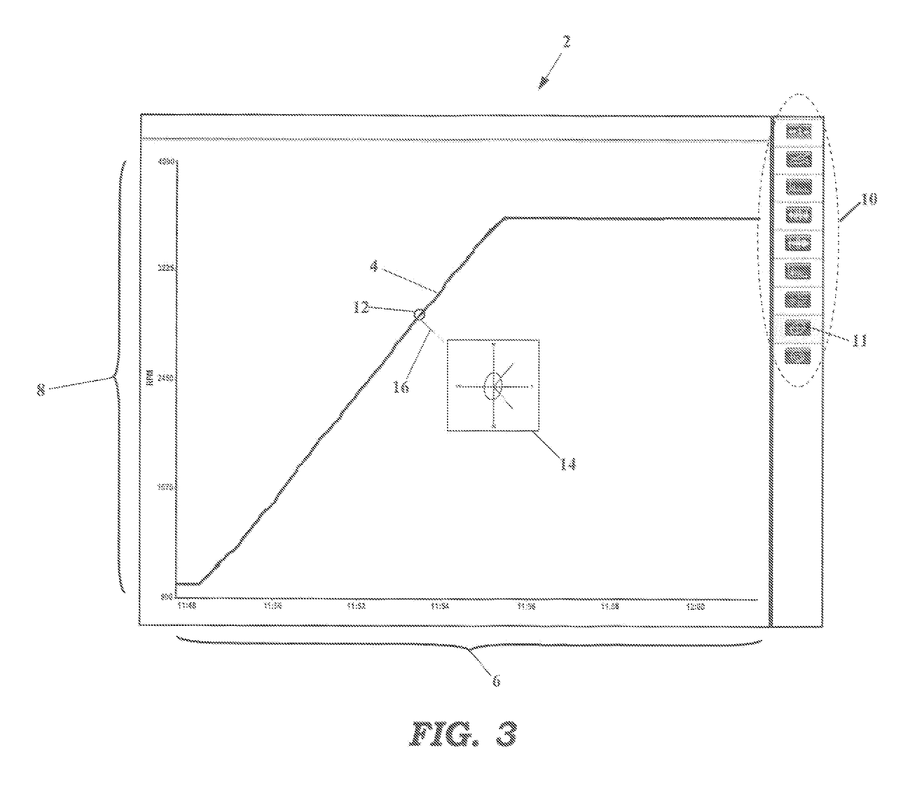

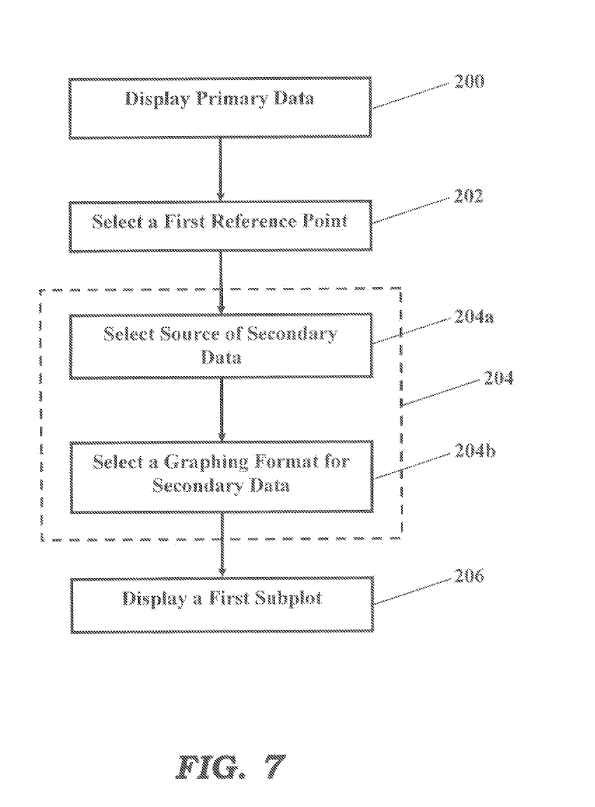

With reference to FIGS. 3 and 7, another embodiment of the method is described. As in the previously described embodiment, primary data 4 is displayed (step 200) and a first reference point 12 is selected by the user (step 202). Subsequent to the selection of the first reference point, the user submits a request for secondary data of interest corresponding to the selected first reference point 12 (step 204). In situations wherein there are multiple sources of secondary data, step 204 includes submitting a request for a particular source of secondary data. The submission of the request for secondary data may be made in several different ways. In a preferred embodiment, the process of submitting the request for secondary data (step 204) includes (1) selecting a particular source of secondary data (step 204a) and (2) selecting a specific type of graphical output format to be used when displaying the requested secondary data on the interactive display device 30 (step 204b). In some embodiments, the selecting step (204a) and the submitting step (204b) may be combined into one step such that the selection of a first reference point 12 also operates as a submission of a request for secondary data corresponding to the first reference point 12 (e.g., if only one type of secondary data is available).

After the submitting the request for secondary data (step 204), the requested data set is accessed and displayed as a sub-plot 14 with the primary data 4 (step 206). The indicator 16 is preferably displayed with the subplot 14 indicating the approximate position of the reference point 12 with which the requested data set is associated. Although the indicator 16 in FIG. 3 is shown as a connecting line, it should be understood that any visual means to correlate the sub-plot 14 with the selected reference point 12 may be used, including curved lines, object indicators (such as footnote-type indicators), color code schemes and other similar indication methods known to those skilled in the art.

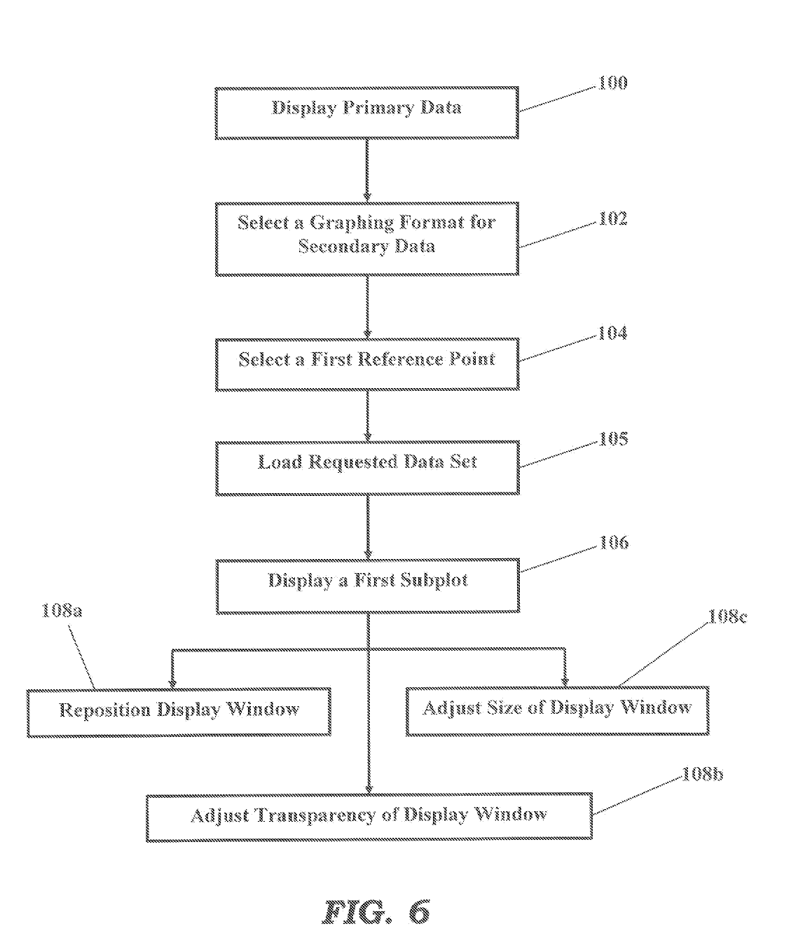

The reference point 12 may correspond to a single datum of primary data 4 or it may indicate a range of one of the dimensions of the primary data 4, such as a time range. Additionally, the user may select a range of the primary data 4 using a mouse or other similar selection device to click and drag a virtual enclosure (e.g., a virtual box) around a particular portion of the primary data 4, thereby defining a first reference point. In the examples shown in FIG. 3, the secondary data represents orbital data indicating the relative position of the center of rotation of a shaft of a turbine in its bearings. In these examples, the secondary data is displayed with the primary data as a subplot 14 (step 106, FIG. 6) so that a user has a static view or “snapshot” of the orbital behavior of the shaft at a time corresponding to the reference point 12 of the primary data 4. The secondary data depicted in the subplot 14 need not be static. In some preferred embodiments, the subplot 14 depicts a replay of “live” data from the period of time corresponding to the reference point 12 (such as in a repeating loop). Alternatively, the primary data 4 may also be live and the user (with a single keystroke) attaches the subplots of secondary data as the primary data develops.

In a preferred embodiment, the subplot 14 is in the form of a display window that may be repositioned within the first graph 2 (step 108a). The indicator 16 preferably associates the subplot 14 with the reference point 12 no matter where the subplot 14 is moved within the graph 2. Also, the subplot 14 may preferably be manipulated to be made more or less transparent or its relative size changed based on user interaction with the interactive display device 30. In a particular embodiment, using plot-on-plot software operating on the interactive display device 30, a fade command is selected by a user to selectively adjust the transparency of the subplot 14 on the display screen 34 to a desired level (step 108b). In another embodiment, a user manipulates a mouse or other similar device to move a screen indicator (such as a common pointer indicator) to adjust the relative size of the subplot 14 (step 108c).

With reference to FIG. 6, in some preferred embodiments, a step of loading a requested data set (step 105) is performed after the submission of a request for secondary data. This loading step may include the transfer of a requested data set from an external storage device 40 to memory 32 within the interactive display device 30. (See FIG. 1.) In another embodiment wherein secondary data is stored in digital memory 32 within the interactive display device 30, the loading step is conducted completely within the interactive display device 30. After the requested data set is loaded (step 105), the secondary data making up the requested data set is displayed on the interactive display device along with primary data (step 106).

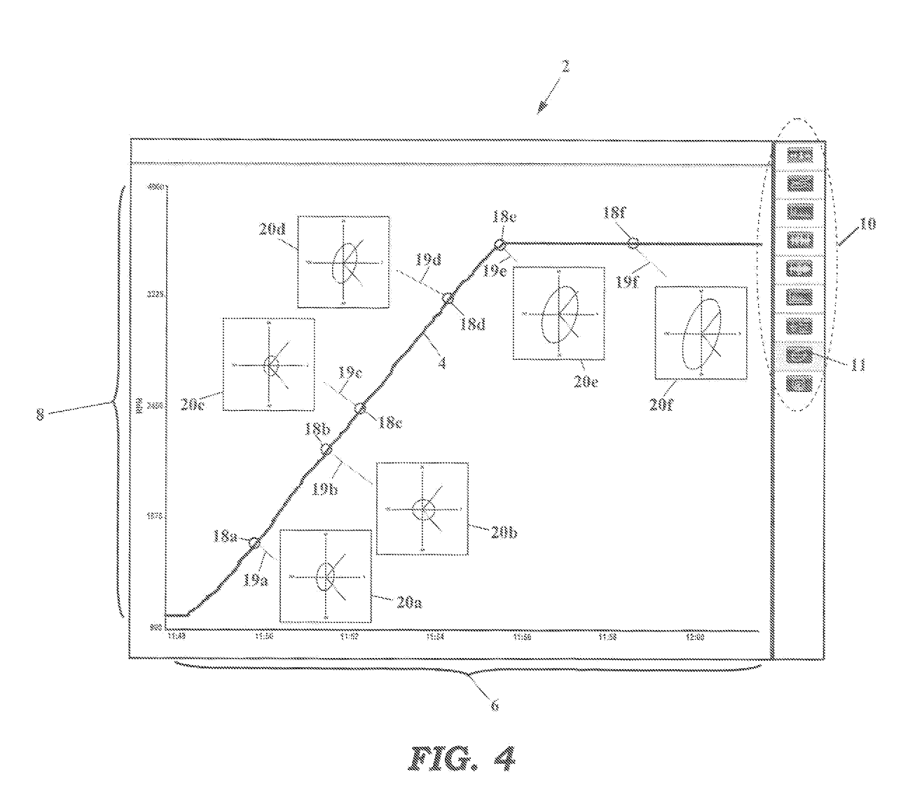

FIG. 4 depicts an example graph 2 wherein RPM is plotted on the Y-axis 8 versus time on the X-axis 6 for the shaft of a turbine. The secondary data displayed in FIG. 4 relates to a particular position “P” along the shaft of the selected turbine monitored by at least two sensors so that accurate orbital data (i.e., the relative position of the shaft and bearings at position “P”) may be acquired. FIG. 4 depicts an example of operation of an embodiment of the invention wherein a user selects a plurality of reference points 18 (such as points 18a, 18b, 18c, 18d, 18e and 18f) on the graph of the primary data 4. The approximate locations along the primary data 4 of the selected reference points 18 are indicated by corresponding indicators 19 (such as indicators 19a, 19b, 19c, 19d, 19e and 19f). The indicators 19 correspond to subplots 20 (such as subplots 20a, 20b, 20c, 20d, 20e, and 20f). In this specific application example, a user may simultaneously obtain a display of RPM data (primary data) and orbital data (secondary data) in a user-friendly format that better communicates to the analyst the positional status of the monitored shaft at various times during turbine start-up. In preferred embodiments, different graphing formats may be selected for each of the subplots 20 of the secondary data.

After displaying the data as shown in FIG. 4 the user may remove the subplots 20 and start over by selecting a new source of secondary data. For example, the user may submit a request for secondary data corresponding to a position “Q” along the shaft that is separate and distinct from the position “P”. In addition, a user may select a graph icon other than the orbital graph icon 11 so that the newly requested secondary data is displayed with the primary data 4 in a different format. A user may also select a first reference point in the primary data 4 and request corresponding secondary data from one secondary data source (e.g., from sensors at position “P” on the shaft), and then select a second reference point in the primary data 4 and request corresponding secondary data from another secondary data source (e.g., from sensors at position “Q” on the shaft). In this way, the two different sources of secondary data can be simultaneously displayed with the graph of the primary data 4. It will be appreciated that secondary data from any conceivable combination and number of data sources could be displayed in combination with a common source of primary data. Similarly, any combination and number of graphical representations can be selected to correspond with the various requested secondary data sets, limited only by available screen space on the display screen 34 and the memory capacity of the memory 32 of the interactive display device 30. As mentioned before, the application examples shown in FIGS. 2-4 are for illustration only and are not meant to be limiting in any way.

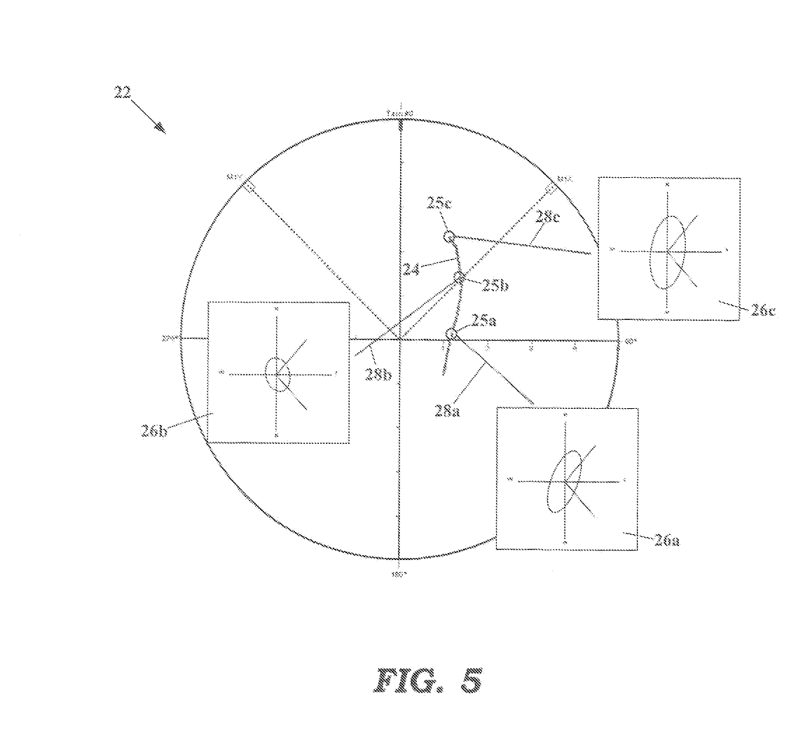

FIG. 5 depicts a second graph 22 of primary data 24. In this illustrative example, the primary data 24 corresponds to the average centerline position of a turbine shaft relative to a fixed centerline position of the overall turbine apparatus. Although the primary data 24 gives an analyst an idea of where the average center position of the shaft is at any given time, the primary data 24 alone cannot give the analyst the necessary information to know the extent of vibration of the shaft (i.e., the extent of the radial movement of the shaft at any given point as it rotates). As in the prior embodiments a user can select a particular graphing format for the secondary data by selecting a graph icon, such as an orbital graph icon. A user may then select a first reference point 25a, thereby defining a data set including orbital data (secondary data) at a particular location along the shaft, such as point “P.” In this example, point “P” on the shaft may correspond to the location of a bearing and related sensors for gathering data. Upon selection of the first reference point 25a, an orbital subplot 26a with a corresponding indicator 28a is generated. A user can then select one or more other reference points, such as 25b and 25c, thereby initiating generation of subplots 26b and 26c with corresponding indicators 28b and 28c. The resultant display including subplots 25a, 25b and 25c gives an analyst a good indication of the movement of the shaft within its bearings at position “P” as well as the average centerline position of the shaft.

It will be appreciated that means for selecting reference points in the data and means for submitting requests for data (such as secondary data) include a combination of hardware components of the apparatus, such as the embodiment depicted in FIG. 1, as well as plot-on-plot computerware (software and/or firmware) operating on the interactive display device 30. The computerware, coupled with the interactive display device 30 allows a user to interact with the interactive display device 30 as shown in FIGS. 2-5 and as described with reference to the methods of FIGS. 6 and 7 as described herein.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for displaying multidimensional data on a display device, the multidimensional data including primary data and secondary data, the method comprising the steps of:
(a) displaying a graph of at least a portion of the primary data on the display device in a first graphing format;
(b) selecting a first reference point in the displayed graph of the primary data;
(c) accessing a first requested data set from the secondary data, the first requested data set indicated by the first reference point; and
(d) displaying a graph of the first requested data set in a second graphing format on the display device with the graph of the primary data.

2. The method of claim 1 wherein step (d) further comprises selecting the second graphing format from among a plurality of graphing formats.

3. The method of claim 2 wherein step (d) further comprises selecting one of a plurality of graph icons displayed on the display device, wherein the selected graph icon represents the second graphing format.

4. The method of claim 1 wherein step (b) comprises selecting a first range of data points in the graph of the primary data.

5. The method of claim 1 wherein step (b) comprises graphically selecting a first area containing a portion of the graph of the primary data displayed on the display device.

6. The method of claim 5 wherein a user uses a mouse to define the first area.

7. The method of claim 1 wherein step (d) further comprises displaying the first requested data set in a display window on the display device with the graph of the primary data.

8. The method of claim 7 wherein the display window is superimposed over at least a portion of the graph of the primary data displayed on the display device.

9. The method of claim 8 further comprising (e) adjusting a transparency setting associated with the superimposed display window whereby the superimposed display window does not fully block the graph of the primary data from view.

10. The method of claim 7 further comprising (e) repositioning the display window with respect to the graph of the primary data based on user interaction.

11. The method of claim 7 further comprising (e) adjusting the size of the display window based on user interaction.

12. The method of claim 7 further comprising (e) displaying an indicator superimposed on the graph of the primary data to indicate an approximate location of the first reference point in the graph of the primary data.

13. The method of claim 1 further comprising the steps of:
(e) selecting a second reference point in the displayed graph of the primary data;
(f) accessing a second requested data set from the secondary data the second requested data set indicated by the second reference point; and
(g) displaying a graph of the second requested data set in the second graphing format on the display device with the graph of the primary data and the graph of the first requested data set.

14. The method of claim 1 further comprising the steps of:
(e) choosing a third graphing format;
(f) selecting a second reference point in the displayed graph of the primary data;
(g) accessing a second requested data set from the secondary data, the second requested data set indicated by the second reference point; and
(h) displaying a graph of the second requested data set in the third graphing format on the display device with the graph of the primary data and the graph of the first requested data set.

15. The method of claim 1 wherein step (c) further comprises selecting a particular source of secondary data.

16. The method of claim 1 further comprising:
(e) accessing a second requested data set from the secondary data, the second requested data set indicated by the first reference point; and
(f) displaying a graph of the second requested data set in the second graphing format on the display device with the graph of the primary data and the graph of the first requested data set.

17. An apparatus for displaying multidimensional data including primary data and secondary data, the apparatus comprising:
means for displaying a graph of at least a portion of the primary data in a first graphing format;
means for selecting a first reference point in the displayed graph of the primary data;
means for accessing a first requested data set from the secondary data, the first requested data set indicated by the first reference point; and
means for displaying a graph of the first requested data set in a second graphing format on the display device with the graph of the primary data.

18. The apparatus of claim 17 further comprising means for selecting the second graphing format from among a plurality of graphing formats.

19. The apparatus of claim 17 further comprising means for selecting the first reference point corresponding to a first range of data points in the graph of the primary data.

20. The apparatus of claim 17 further comprising means for displaying the first requested data set in a display window superimposed over at least a portion of the graph of the primary data.

21. The apparatus of claim 20 further comprising means for adjusting transparency of the superimposed display window.

22. The apparatus of claim 20 further comprising means for repositioning the display window with respect to the graph of the primary data based on user interaction.

23. The apparatus of claim 20 further comprising means for adjusting the size of the display window based on user interaction.

24. The apparatus of claim 17 further comprising means for displaying an indicator superimposed on the graph of the primary data to indicate an approximate location of the first reference point in the graph of the primary data.

25. The apparatus of claim 17 further comprising mass storage means for storing the primary data and the secondary data, wherein the means for displaying a graph of at least a portion of the primary data selectively loads the primary data from the mass storage means, and the means for accessing a first requested data set from the secondary data selectively loads the secondary data from the mass storage means.

26. A method for displaying test data on a display screen, the test data including at least primary data which comprises first dimension data measured as a function of second dimension data and secondary data which comprises third dimension data measured as a function of fourth dimension data, wherein the third and fourth dimension data are measured as a function of the second dimension data, the method comprising:
(a) plotting the first dimension data versus the second dimension data in a first graph on the display screen;
(b) selecting at least a first location in the first graph, the first location indicating at least one data point in the second dimension data;
(c) accessing a first subset of the secondary data, the first subset including third dimension data and fourth dimension data corresponding to the at least one second dimension data point indicated by the first location; and
(d) plotting the first subset of the secondary data in a second graph on the display screen.

27. The method of claim 26 wherein the second dimension data comprises time data, and wherein:
step (a) comprises plotting first dimension data versus time in the first graph;
step (b) comprises selecting the first location indicating at least one time value in the time data; and
step (c) comprises accessing the first subset of the secondary data including third dimension data and fourth dimension data corresponding to the at least one time value indicated by the first location.

28. The method of claim 26 further comprising:
(e) selecting a second location on the first graph, the second location indicating at least one data point in the second dimension data;
(f) accessing a second subset of the secondary data, the second subset including third dimension data and fourth dimension data corresponding to the at least one second dimension data point indicated by the second location; and
(g) plotting the second subset of the secondary data in a third graph on the display screen.

29. The method of claim 26 further comprising (e) plotting an indicator on the first graph, the indicator visually linking the second graph to the first location on the first graph.
